(19) United States
(12) Patent Application Publication
(10) Pub. No.: US 2024/0145775 A1
(43) Pub. Date: May 2, 2024

(54) ELECTROLYTES AND COMPONENTS THEREOF

(71) Applicant: Rivian IP Holdings, LLC, Plymouth, MI (US)

(72) Inventors: Liyuan Sun, Mountain View, CA (US); Sookyung Jeong, San Jose, CA (US); Soo Kim, Fremont, CA (US); Tae Kyoung Kim, Albany, CA (US); Ki Tae Park, Santa Clara, CA (US); Judith Alvarado Kim, San Leandro, CA (US)

(21) Appl. No.: 18/049,873

(22) Filed: Oct. 26, 2022

(51) Int. Cl. H01M 10/0567; H01M 10/0569

(52) U.S. Cl. CPC H01M 10/0567; H01M 10/0569; H01M 2300/0028

(57) ABSTRACT

Provided herein is a battery cell. The battery cell can include a cathode. The cathode can include a cathode active material. The battery cell can include an anode. The anode can include an anode active material. The battery cell can include an electrolyte. The electrolyte can include a ring-opening compound. The ring-opening compound can include a fluorocarbonate. The electrolyte can include a heterocyclic compound. The electrolyte can include dimethyl carbonate. The ring-opening compound can increase decomposition of the heterocyclic compound in the electrolyte compared to the same electrolyte without the ring-opening compound.

### INTRODUCTION

Batteries can have different power capacities to charge and discharge power to operate machines.

### SUMMARY

Batteries such as lithium-ion batteries can have reduced power capability at low temperatures. The solutions described herein can enhance the low-temperature cycling performance of batteries cells and improve the solid electrolyte interphase formed on an electrode of the battery cells.

At least one aspect is directed to a battery cell. The battery cell can include a cathode. The cathode can include a cathode active material. The battery cell can include an anode. The anode can include an anode active material. The battery cell can include an electrolyte. The electrolyte can include a ring-opening compound. The ring-opening compound can include a fluorocarbonate. The electrolyte can include a heterocyclic compound. The electrolyte can include dimethyl carbonate. The ring-opening compound can increase decomposition of the heterocyclic compound in the electrolyte compared to the same electrolyte without the ring-opening compound.

At least one aspect is directed to a battery cell. The battery cell can include a cathode. The cathode can include a cathode active material. The battery cell can include an anode. The anode can include an anode active material. The battery cell can include an electrolyte. The electrolyte can include an additive. The additive can include fluoroethylene carbonate, ethylene sulfite, and vinylene carbonate.

At least one aspect is directed to a method. The method can include providing a battery cell. The battery cell can include a cathode. The cathode can include a cathode active material. The battery cell can include an anode. The anode can include an anode active material. The method can include providing an electrolyte. The electrolyte can include a ring-opening compound. The ring-opening compound can include a fluorocarbonate. The electrolyte can include a heterocyclic compound. The electrolyte can include dimethyl carbonate. The ring-opening compound can increase decomposition of the heterocyclic compound in the electrolyte compared to the same electrolyte without the ring-opening compound

At least one aspect is directed to an electric vehicle. The electric vehicle can include a battery cell. The battery cell can include a cathode. The cathode can include a cathode active material. The battery cell can include an anode. The anode can include an anode active material. The battery cell can include an electrolyte. The electrolyte can include a ring-opening compound. The ring-opening compound can include a fluorocarbonate. The electrolyte can include a heterocyclic compound. The electrolyte can include dimethyl carbonate. The ring-opening compound can increase decomposition of the heterocyclic compound in the electrolyte compared to the same electrolyte without the ring-opening compound.

At least one aspect is directed to a system. The system can include a battery cell. The battery cell can include a cathode. The cathode can include a cathode active material. The battery cell can include an anode. The anode can include an anode active material. The battery cell can include an electrolyte. The electrolyte can include a ring-opening compound. The ring-opening compound can include a fluorocarbonate. The electrolyte can include a heterocyclic compound. The electrolyte can include dimethyl carbonate. The ring-opening compound can increase decomposition of the heterocyclic compound in the electrolyte compared to the same electrolyte without the ring-opening compound.

At least one aspect is directed to a battery. The battery can include a cathode. The cathode can include a cathode active material. The battery can include an anode. The anode can include an anode active material. The battery can include an electrolyte. The electrolyte can include an additive. The electrolyte can include a ring-opening compound. The ring-opening compound can include a fluorocarbonate. The electrolyte can include a heterocyclic compound. The electrolyte can include dimethyl carbonate. The ring-opening compound can increase decomposition of the heterocyclic compound in the electrolyte compared to the same electrolyte without the ring-opening compound.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a cross-sectional view of an electric vehicle, according to an example implementation.

FIG. 2A depicts a battery pack, according to an example implementation.

FIG. 2B depicts a battery module, according to an example implementation.

FIG. 2C depicts a cross-sectional view of a battery cell, according to an example implementation.

FIG. 2D depicts a cross sectional view of a battery cell, according to an example implementation.

FIG. 2E depicts a cross sectional view of a battery cell, according to an example implementation.

FIG. 3 depicts a perspective view of a battery cell, according to an example implementation.

FIG. 4 depicts a schematic illustration of a solid electrolyte interphase formed from an electrolyte without ethylene sulfite and a solid electrolyte interphase formed from an electrolyte with ethylene sulfite, according to an example implementation.

FIG. 5 depicts a graph of discharge impedance at 50% state-of-charge at 23° C. for an improved electrolyte and a control electrolyte, according to an example implementation.

FIG. 6 depicts a graph of charge impedance at 50% state-of-charge at 23° C. for an improved electrolyte and a control electrolyte, according to an example implementation.

FIG. 7 depicts a graph of discharge impedance at 50% state-of-charge at −10° C. for an improved electrolyte and a control electrolyte, according to an example implementation.

FIG. 8 depicts a graph of charge impedance at 50% state-of-charge at −10° C. for an improved electrolyte and a control electrolyte, according to an example implementation.

FIG. 9 depicts a plot of capacity retention vs. cycle number at 45° C. for an improved electrolyte and a control electrolyte, according to an example implementation.

FIG. 10 depicts a method of improving battery cell performance, according to an example implementation.

FIG. 11 depicts a method of providing a battery cell, according to an example implementation.

### DETAILED DESCRIPTION

Following below are more detailed descriptions of various concepts related to, and implementations of, methods, apparatuses, and systems for electrolytes. The various concepts introduced above and discussed in greater detail below may be implemented in any of numerous ways.

The present disclosure is directed to systems and methods for electrolytes with improved additive formulations. Batteries such as lithium-ion batteries can have reduced power capability at lower temperatures. Performance of lithium-ion batteries at lower temperatures can be limited due to resistive interfaces originating from electrolyte decomposition and reduced electrolyte wetting for high density electrodes. Solvents used to reduce the viscosity of the electrolyte can negatively affect the conductivity of the electrolyte at lower temperatures.

Systems and methods of the present technical solution can provide a battery cell including an improved electrolyte (e.g., electrolyte). The battery cell can include a cathode including a cathode active material and an anode including an anode active material. The electrolyte can include a ring-opening compound. The ring-opening compound can include a fluorocarbonate. The electrolyte can include a heterocyclic compound. The electrolyte can include dimethyl carbonate. The ring-opening compound can increase decomposition of the heterocyclic compound in the electrolyte compared to the same electrolyte without the ring-opening compound.

The disclosed solutions have a technical advantage of improving battery cell performance. The solutions can enhance the low-temperature cycling performance of batteries cells. The solutions can improve the solid electrolyte interphase formed on an electrode of the battery cell. The solutions can reduce the cell impedance at various temperatures (e.g., room temperature, lower temperature). The solutions can improve cycle life at various temperatures (e.g., elevated temperature). The solutions can improve the power performance of the battery cell.

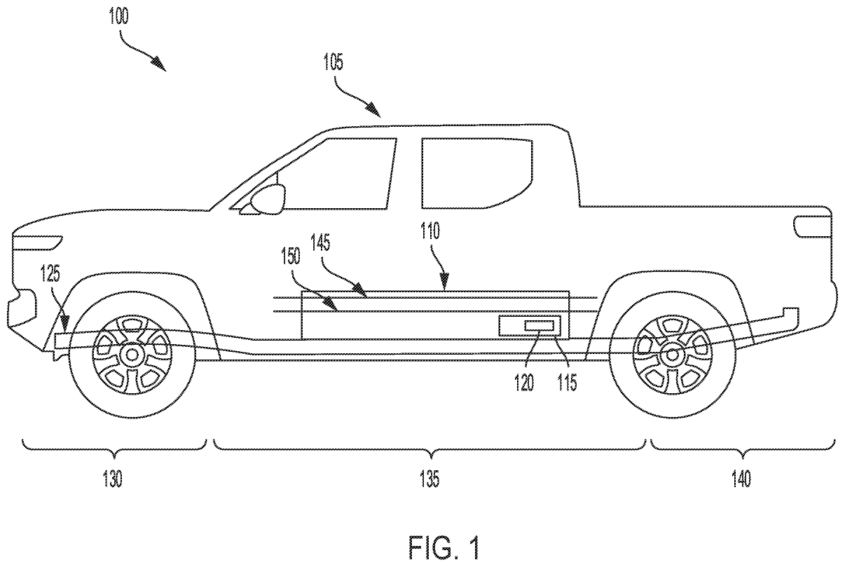

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the electric vehicle 105 to provide electrical power to various systems or components of the electric vehicle 105.

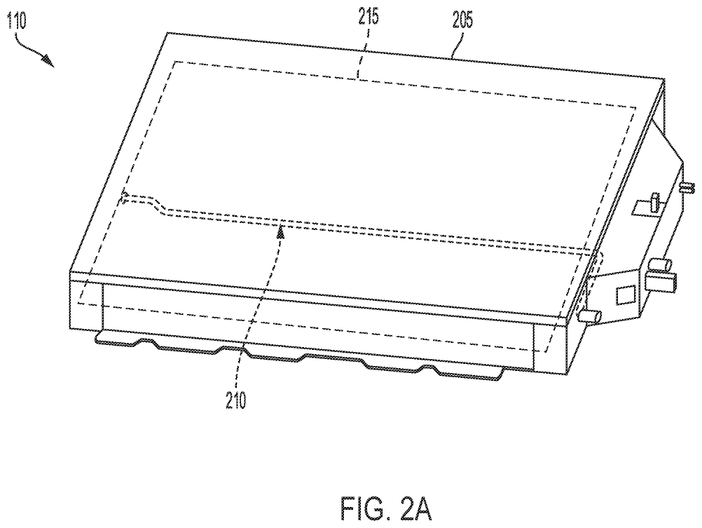

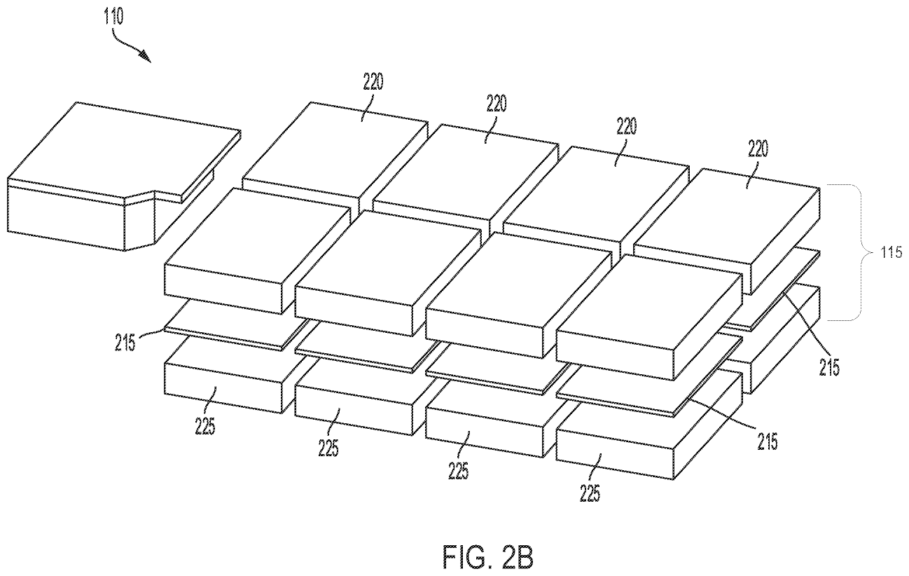

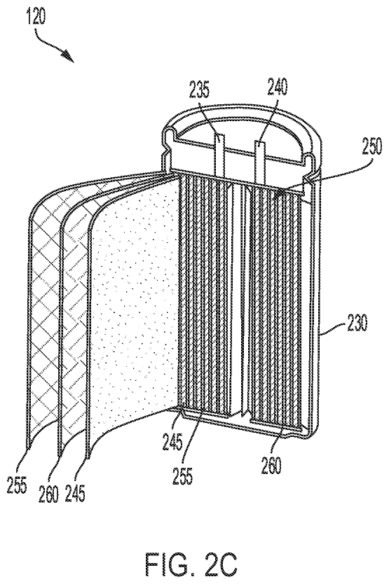

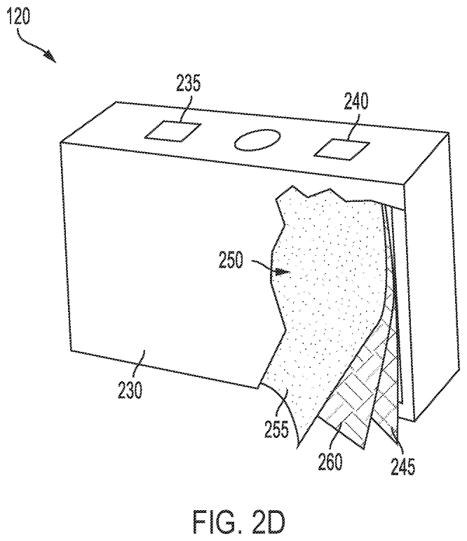

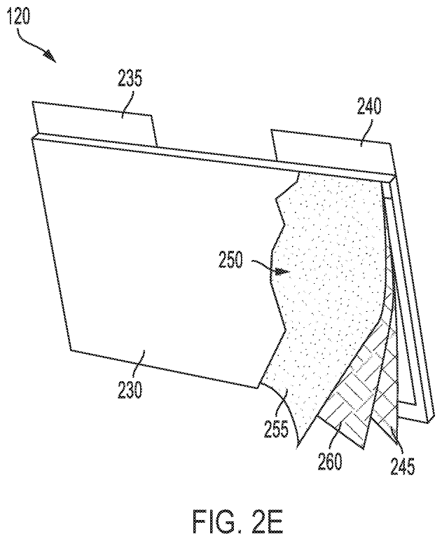

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The battery module 115 can be or can include one or more groups of prismatic cells, cylindrical cells, pouch cells, or other form factors of battery cells 120. The housing 205 can include a shield on the bottom or underneath the battery module 115 to protect the battery module 115 and/or cells 120 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery module 115. At least one cooling line 210 can be coupled with, part of, or independent from the thermal component 215.

FIG. 2B depicts example battery modules 115, and FIGS. 2C, 2D and 2E depict an example cross sectional view of a battery cell 120. The battery modules 115 can include at least one submodule. For example, the battery modules 115 can include at least one first (e.g., top) submodule 220 or at least one second (e.g., bottom) submodule 225. At least one thermal component 215 can be disposed between the top submodule 220 and the bottom submodule 225. For example, one thermal component 215 can be configured for heat exchange with one battery module 115. The thermal component 215 can be disposed or thermally coupled between the top submodule 220 and the bottom submodule 225. One thermal component 215 can also be thermally coupled with more than one battery module 115 (or more than two submodules 220, 225). The thermal components 215 shown adjacent to each other can be combined into a single thermal component 215 that spans the size of one or more submodules 220 or 225. The thermal component 215 can be positioned underneath submodule 220 and over submodule 225, in between submodules 220 and 225, on one or more sides of submodules 220, 225, among other possibilities. The thermal component 215 can be disposed in sidewalls, cross members, structural beams, among various other components of the battery pack, such as battery pack 110 described above. The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a thermal component 215 in between the top submodule 220 and the bottom submodule 225. The battery pack 110 can include or define a plurality of areas for positioning of the battery module 115 and/or cells 120. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120. It should be noted the illustrations and descriptions herein are provided for example purposes and should not be interpreted as limiting. For example, the battery cells 120 can be inserted in the battery pack 110 without battery modules 220 and 225. The battery cells 120 can be disposed in the battery pack 110 in a cell-to-pack configuration without modules 220 and 225, among other possibilities.

Battery cells 120 have a variety of form factors, shapes, or sizes. For example, battery cells 120 can have a cylindrical, rectangular, square, cubic, flat, pouch, elongated or prismatic form factor. As depicted in FIG. 2C, for example, the battery cell 120 can be cylindrical. As depicted in FIG. 2D, for example, the battery cell 120 can be prismatic. As depicted in FIG. 2E, for example, the battery cell 120 can include a pouch form factor. Battery cells 120 can be assembled, for example, by inserting a winded or stacked electrode roll (e.g., a jelly roll) including electrolyte material into at least one battery cell housing 230. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 120 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 120. The housing 230 can be of various shapes, including cylindrical or rectangular, for example. Electrical connections can be made between the electrolyte material and components of the battery cell 120. For example, electrical connections to the electrodes with at least some of the electrolyte material can be formed at two points or areas of the battery cell 120, for example to form a first polarity terminal 235 (e.g., a positive or anode terminal) and a second polarity terminal 240 (e.g., a negative or cathode terminal). The polarity terminals can be made from electrically conductive materials to carry electrical current from the battery cell 120 to an electrical load, such as a component or system of the electric vehicle 105.

For example, the battery cell 120 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode.

The battery cell 120 can be included in battery modules 115 or battery packs 110 to power components of the electric vehicle 105. The battery cell housing 230 can be disposed in the battery module 115, the battery pack 110, or a battery array installed in the electric vehicle 105. The housing 230 can be of any shape, such as cylindrical with a circular (e.g., as depicted in FIG. 2C, among others), elliptical, or ovular base, among others. The shape of the housing 230 can also be prismatic with a polygonal base, as shown in FIG. 2D, among others. As shown in FIG. 2E, among others, the housing 230 can include a pouch form factor. The housing 230 can include other form factors, such as a triangle, a square, a rectangle, a pentagon, and a hexagon, among others. In some embodiments, the battery pack may not include modules (e.g., module-free). For example, the battery pack can have a module-free or cell-to-pack configuration where the battery cells are arranged directly into a battery pack without assembly into a module.

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 230 of the battery cell 120 is prismatic (e.g., as depicted in FIG. 2D, among others) or cylindrical (e.g., as depicted in FIG. 2C, among others), the housing 230 can include a rigid or semi-rigid material such that the housing 230 is rigid or semi-rigid (e.g., not easily deformed or manipulated into another shape or form factor). In examples where the housing 230 includes a pouch form factor (e.g., as depicted in FIG. 2E, among others), the housing 230 can include a flexible, malleable, or non-rigid material such that the housing 230 can be bent, deformed, manipulated into another form factor or shape.

The battery cell 120 can include at least one anode layer 245, which can be disposed within the cavity 250 defined by the housing 230. The anode layer 245 can include a first redox potential. The anode layer 245 can receive electrical current into the battery cell 120 when charged and output electrons during the operation of the battery cell 120 (e.g., charging or discharging of the battery cell 120). The anode layer 245 can include an active substance. The active substance can include, for example, an activated carbon or a material infused with conductive materials (e.g., artificial or natural graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp² hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 120 can include at least one cathode layer 255 (e.g., a composite cathode layer compound cathode layer, a compound cathode, a composite cathode, or a cathode). The cathode layer 255 can include a second redox potential that can be different than the first redox potential of the anode layer 245. The cathode layer 255 can be disposed within the cavity 250. The cathode layer 255 can output electrical current out from the battery cell 120 and can receive electrons during the discharging of the battery cell 120. The cathode layer 255 can also receive lithium ions during the discharging of the battery cell 120. Conversely, the cathode layer 255 can receive electrical current into the battery cell 120 and can output electrons during the charging of the battery cell 120. The cathode layer 255 can release lithium ions during the charging of the battery cell 120.

The battery cell 120 can include an electrolyte layer 260 disposed within the cavity 250. A separator can be wetted with a liquid electrolyte. The liquid electrolyte can be diffused into the anode layer 245. The liquid electrolyte can be diffused into the cathode layer 255. The electrolyte layer 260 can help transfer ions between the anode layer 245 and the cathode layer 255. The electrolyte layer 260 can transfer Li⁺ cations from the anode layer 245 to the cathode layer 255 during the discharge operation of the battery cell 120. The electrolyte layer 260 can transfer lithium ions from the cathode layer 255 to the anode layer 245 during the charge operation of the battery cell 120.

The redox potential of layers (e.g., the first redox potential of the anode layer 245 or the second redox potential of the cathode layer 255) can vary based on a chemistry of the respective layer or a chemistry of the battery cell 120. For example, lithium-ion batteries can include an LFP (lithium iron phosphate) chemistry, an LMFP (lithium manganese iron phosphate) chemistry, an NMC (nickel manganese cobalt) chemistry, an NCA (nickel cobalt aluminum) chemistry, an OLO (over lithiated oxide) chemistry, or an LCO (lithium cobalt oxide) chemistry for a cathode layer (e.g., the cathode layer 255). Lithium-ion batteries can include a graphite chemistry, a silicon-graphite chemistry, or a lithium metal chemistry for the anode layer (e.g., the anode layer 245).

For example, lithium-ion batteries can include an olivine phosphate (LiMPO₄, M=Fe and/or Co and/or Mn and/or Ni)) chemistry, LISICON or NASICON Phosphates (Li₃M₂(PO₄)₃ and LiMPO₄Ox, M=Ti, V, Mn, Cr, and Zr), for example lithium iron phosphate (LFP), lithium manganese iron phosphate (LMFP), layered oxides (LiMO₂, M=Ni and/or Co and/or Mn and/or Fe and/or Al and/or Mg) examples, NMC (nickel manganese cobalt) chemistry, an NCA (nickel cobalt aluminum) chemistry, or an LCO (lithium cobalt oxide) chemistry for a cathode layer, Lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 255). Lithium-ion batteries can include a graphite chemistry, a silicon-graphite chemistry, or a lithium metal chemistry for the anode layer (e.g., the anode layer 245). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, or other additives as a coating on a current collector (metal foil). The chemical composition of the electrode layers can affect the redox potential of the electrode layers. For example, cathode layers (e.g., the cathode layer 255) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and lithium manganese iron phosphate (“LMFP”). Anode layers (e.g., the anode layer 245) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, and/or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The electrolyte layer 260 can include or be made of a liquid electrolyte material. For example, the electrolyte layer 260 can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the electrolyte layer 260 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others.

In examples where the electrolyte layer 260 includes a liquid electrolyte material, the electrolyte layer 260 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The non-aqueous polar solvent can also include ethyl propionate as a diluent. The electrolyte layer 260 can include at least one additive. The additives can be or include vinylene carbonate, fluoroethylene carbonate, ethylene sulfite, tris(trimethylsilyl) phosphate, ethyl propionate, methyl propionate, methyl acetate, ethyl acetate, a heterocyclic compound, or a mixture of any two or more thereof. The electrolyte layer 260 can include a lithium salt material. For example, the lithium salt can be lithium tetrafluoroborate, lithium hexafluorophosphate, lithium bis(trifluorosulfonyl)imide, or a mixture of any two or more thereof. The lithium salt may be present in the electrolyte layer 260 from greater than 0 M to about 1.5 M.

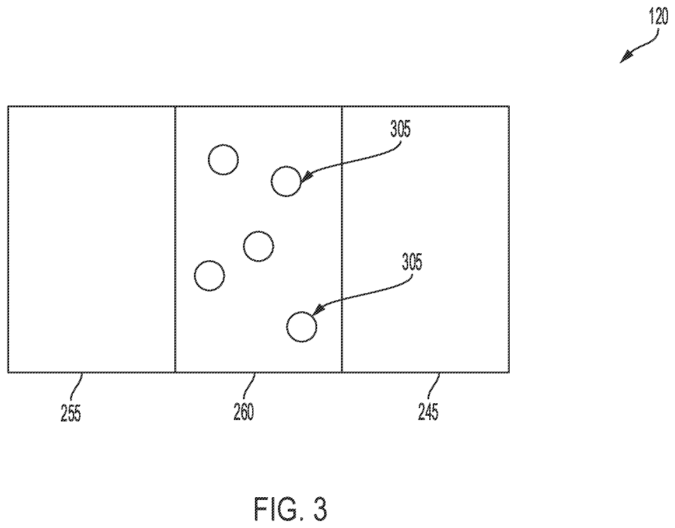

FIG. 3 depicts a perspective view of the battery cell 120. The battery cell 120 can include at least one anode (e.g., anode layer 245). The anode can include an anode active material. The anode active material can include artificial graphite, natural graphite, or a combination thereof.

The anode active material can have an areal density of at least 4.8 mg/cm². For example, the anode active material can have an areal density of at least 4.8 mg/cm², at least 5 mg/cm², at least 10 mg/cm², or at least 15 mg/cm². The anode active material can have an areal density in a range of 4.8 mg/cm² to 20 mg/cm². For example, the anode active material can have an areal density in a range of 4.8 mg/cm² to 5 mg/cm², 4.8 mg/cm² to 10 mg/cm², 4.8 to 15 mg/cm², 4.8 to 20 mg/cm², 5 mg/cm² to 10 mg/cm², 5 to 15 mg/cm², 5 to 20 mg/cm², 10 to 15 mg/cm², 10 to 20 mg/cm², or 15 to 20 mg/cm². The anode active material can exhibit an areal density in the range of 4.8 mg/cm² to 20 mg/cm² on a single side of a current collector.

The anode active material can have a press density of at least 1.4 g/cm³. For example, the anode active material can have a press density of at least 1.4 g/cm³, at least 1.5 g/cm³, at least 1.6 g/cm³, at least 1.7 g/cm³, at least 1.8 g/cm³, or at least 1.9 g/cm³. The anode active material can have a press density in a range of 1.4 g/cm³ to 2.0 g/cm³. For example, the anode active material can have a press density in a range of 1.4 g/cm³ to 1.6 g/cm³, 1.4 g/cm³ to 1.8 g/cm³, 1.4 g/cm³ to 2.0 g/cm³, 1.6 g/cm³ to 1.8 g/cm³, 1.6 g/cm³ to 2.0 g/cm³, or 1.8 g/cm³ to 2.0 g/cm³. The press density can be measured after a calendaring or roll pressing of the electrode.

The battery cell 120 can include at least one cathode (e.g., cathode layer 255). The cathode can include a cathode active material. The cathode active material can include lithium iron phosphate (e.g., LiFePO₄, LFP), lithium manganese iron phosphate (LMFP), nickel manganese, and cobalt (NMC), nickel, cobalt, and aluminum (NCA), lithium cobalt oxide (LCO), over-lithiated layered oxides (OLO), or a combination thereof.

The cathode active material can have an areal density of at least 12 mg/cm². For example, the cathode active material can have an areal density of at least 12 mg/cm², at least 15 mg/cm², at least 20 mg/cm², at least 25 mg/cm², or at least 30 mg/cm². The cathode active material can have an areal density in a range of 12 mg/cm² to 35 mg/cm². For example, the cathode active material can have an areal density in a range of 12 mg/cm² to 15 mg/cm², 12 mg/cm² to 20 mg/cm², 12 mg/cm² to 25 mg/cm², 12 mg/cm² to 30 mg/cm², 12 mg/cm² to 35 mg/cm², 15 mg/cm² to 20 mg/cm², 15 mg/cm² to 25 mg/cm², 15 mg/cm² to 30 mg/cm², 15 mg/cm² to 35 mg/cm², 20 mg/cm² to 25 mg/cm², 20 mg/cm² to 30 mg/cm², 20 mg/cm² to 35 mg/cm², 25 mg/cm² to 30 mg/cm², 25 mg/cm² to 35 mg/cm², or 30 mg/cm² to 35 mg/cm². The cathode active material can exhibit an areal density in the range of 12 mg/cm² to 30 mg/cm² on a single side of a current collector.

The cathode active material can have a press density of at least 2.0 g/cm³. For example, the cathode active material can have a press density of at least 2.0 g/cm³, or at least 3.0 g/cm³. The cathode active material can have a press density in a range of 2.0 g/cm³ to 4.0 g/cm³. For example, the cathode active material can have a press density of 2.0 g/cm³ to 2.5 g/cm³, 2.0 g/cm³ to 3.0 g/cm³, 2.0 g/cm³ to 3.5 g/cm³, 2.0 to 4.0 g/cm³, 2.5 g/cm³ to 3.0 g/cm³, 2.5 g/cm³ to 3.5 g/cm³, 2.5 to 4.0 g/cm³, 3.0 g/cm³ to 3.5 g/cm³, 3.0 to 4.0 g/cm³, or 3.5 to 4.0 g/cm³. The press density can be measured after a calendaring or roll pressing of the electrode.

The battery cell 120 can include at least one electrolyte (e.g., electrolyte layer 260). The electrolyte can include at least one additive 305. The additive 305 can include a ring-opening compound. The ring-opening compound can include a fluorocarbonate. The fluorocarbonate can include fluoroethylene carbonate (FEC). The ring-opening compound can increase decomposition of a component or additive in the battery cell 120 compared to the same electrolyte without the ring-opening compound. For example, the ring-opening compound can increase decomposition of a heterocyclic compound (e.g., heterocyclic additive) in the electrolyte including dimethyl carbonate compared to the same electrolyte without the ring-opening compound. The electrolyte can include a ring-opening including a fluorocarbonate, a heterocyclic compound, and dimethyl carbonate. The electrolyte can include a solvent. The solvent can include dimethyl carbonate.

The additive 305 can include fluoroethylene carbonate. The additive 305 can include fluoroethylene carbonate in a range of 0.1 wt % to 10 wt %. For example, the additive 305 can include fluoroethylene carbonate in a range of 0.1 wt % to 0.5 wt %, 0.1 wt % to 1 wt %, 0.1 wt % to 2 wt %, 0.1 wt % to 5 wt %, 0.1 wt % to 10 wt %, 0.5 wt % to 1 wt %, 0.5 wt % to 2 wt %, 0.5 wt % to 5 wt %, 0.5 wt % to 10 wt %, 2 wt % to 2 wt %, 2 wt % to 5 wt %, 2 wt % to 10 wt %, 2 wt % to 5 wt %, 2 wt % to 10 wt %, or 1 wt % to 10 wt %.

The additive 305 can include a heterocyclic compound. For example, the heterocyclic compound can include a sultone, a sulfonate, a sulfite (e.g., ethylene sulfite, ES), or a combination thereof. The additive 305 can include the heterocyclic compound in a range of 0.1 wt % to 5 wt %. For example, the additive 305 can include the heterocyclic compound in a range of 0.1 wt % to 0.5 wt %, 0.1 wt % to 1 wt %, 0.1 wt % to 2 wt %, 0.1 wt % to 3 wt %, 0.1 wt % to 4 wt %, 0.1 wt % to 5 wt %, 0.5 wt % to 1 wt %, 0.5 wt % to 2 wt %, 0.5 wt % to 3 wt %, 0.5 wt % to 4 wt %, 0.5 wt % to 5 wt %, 1 wt % to 2 wt %, 1 wt % to 3 wt %, 1 wt % to 4 wt %, 1 wt % to 5 wt %, 2 wt % to 3 wt %, 2 wt % to 4 wt %, 2 wt % to 5 wt %, 3 wt % to 4 wt %, 3 wt % to 5 wt %, or 4 wt % to 5 wt %. The fluoroethylene carbonate can facilitate decomposition of the heterocyclic compound. For example, the fluoroethylene carbonate can facilitate the ring-opening decomposition of the ethylene sulfite. The decomposition of ethylene sulfite can be hindered by a dimethyl carbonate (DMC) co-solvent. Dimethyl carbonate can reduce the conductivity of the electrolyte at low temperatures.

The additive 305 can include vinylene carbonate (VC). The additive 305 can include vinylene carbonate in a range of 0.1 wt % to 5 wt %. For example, the additive 305 can include vinylene carbonate in a range of 0.1 wt % to 0.5 wt %, 0.1 wt % to 1 wt %, 0.1 wt % to 2 wt %, 0.1 wt % to 3 wt %, 0.1 wt % to 4 wt %, 0.1 wt % to 5 wt %, 0.5 wt % to 1 wt %, 0.5 wt % to 2 wt %, 0.5 wt % to 3 wt %, 0.5 wt % to 4 wt %, 0.5 wt % to 5 wt %, 1 wt % to 2 wt %, 1 wt % to 3 wt %, 1 wt % to 4 wt %, 1 wt % to 5 wt %, 2 wt % to 3 wt %, 2 wt % to 4 wt %, 2 wt % to 5 wt %, 3 wt % to 4 wt %, 3 wt % to 5 wt %, or 4 wt % to 5 wt %.

The additive 305 can include tris(trimethylsilyl) phosphate (TMSPa). Each tris(trimethylsilyl) phosphate molecule can possess four oxygen atoms in the forms of P═O and P—O—Si. The additive 305 can include tris(trimethylsilyl) phosphate in a range of 0 wt % to 1 wt %. For example, the additive 305 can include tris(trimethylsilyl) phosphate in a range of 0 wt % to 0.25 wt %, 0 wt % to 0.5 wt %, 0 wt % to 0.75 wt %, 0 wt % to 1 wt %, 0.25 wt % to 0.5 wt %, 0.25 wt % to 0.75 wt %, 0.25 wt % to 1 wt %, 0.5 wt % to 0.75 wt %, 0.5 wt % to 1 wt %, or 0.75 wt % to 1 wt %. The additive 305 can include (R₃SiO)₃P(O), (R₃SiO)₃P, or mixture of any two or more thereof. R can include methyl or ethyl. R can include a C₁-C₄ alkyl group. For example, the additive 305 can include (R₃SiO)₃P(O), (R₃SiO)₃P, or mixture of any two or more thereof in a range of 0 wt % to 0.25 wt %, 0 wt % to 0.5 wt %, 0 wt % to 0.75 wt %, 0 wt % to 1 wt %, 0.25 wt % to 0.5 wt %, 0.25 wt % to 0.75 wt %, 0.25 wt % to 1 wt %, 0.5 wt % to 0.75 wt %, 0.5 wt % to 1 wt %, or 0.75 wt % to 1 wt %.

The electrolyte can include a solvent. The solvent can include ethylene carbonate, propylene carbonate, ethyl methyl carbonate, dimethyl carbonate, ethyl propionate, or a combination thereof. The solvent can include ethylene carbonate in a range of 20 wt % to 30 wt %. For example, the solvent can include ethylene carbonate in a range of 20 wt % to 25 wt %, 20 wt % to 30 wt %, or 25 wt % to 30 wt %. The solvent can include propylene carbonate in a range of 0 wt % to 10%. For example, the solvent can include propylene carbonate in a range of 0 wt % to 5 wt %, 0 wt % to 10 wt %, or 5 wt % to 10 wt %. The solvent can reduce the viscosity of the electrolyte. The solvent can increase the wettability of the electrolyte. For example, the solvent can increase the wettability of the electrolyte at low temperatures (e.g., a temperature less than or equal to −10° C.).

The solvent can include ethyl methyl carbonate in a range of 20 wt % to 50%. For example, the solvent can include ethyl methyl carbonate in a range of 20 wt % to 25 wt %, 20 wt % to 30 wt %, 20 wt % to 35 wt %, 20 wt % to 40 wt %, 20 wt % to 45 wt %, 20 wt % to 50 wt %, 25 wt % to 30 wt %, 25 wt % to 35 wt %, 25 wt % to 40 wt %, 25 wt % to 45 wt %, 25 wt % to 50 wt %, 30 wt % to 35 wt %, 30 wt % to 40 wt %, 30 wt % to 45 wt %, 30 wt % to 50 wt %, 35 wt % to 40 wt %, 35 wt % to 45 wt %, 35 wt % to 50 wt %, 40 wt % to 45 wt %, 40 wt % to 50 wt %, or 45 wt % to 50 wt %.

The solvent can include dimethyl carbonate in a range of 0 wt % to 30%. For example, the solvent can include dimethyl carbonate in a range of 0 wt % to 5 wt %, 0 wt % to 10 wt %, 0 wt % to 15 wt %, 0 wt % to 20 wt %, 0 wt % to 25 wt %, 0 wt % to 30 wt %, 5 wt % to 10 wt %, 5 wt % to 15 wt %, 5 wt % to 20 wt %, 5 wt % to 25 wt %, 5 wt % to 30 wt %, 10 wt % to 15 wt %, 10 wt % to 20 wt %, 10 wt % to 25 wt %, 10 wt % to 30 wt %, 15 wt % to 20 wt %, 15 wt % to 25 wt %, 15 wt % to 30 wt %, 20 wt % to 25 wt %, 20 wt % to 30 wt %, or 25 wt % to 30 wt %.

The solvent can include ethyl propionate in a range of 0 wt % to 20 wt %. For example, the solvent can include ethyl propionate in a range of 0 wt % to 5 wt %, 0 wt % to 10 wt %, 0 wt % to 15 wt %, 0 wt % to 20 wt %, 5 wt % to 10 wt %, 5 wt % to 15 wt %, 5 wt % to 20 wt %, 10 wt % to 15 wt %, 10 wt % to 20 wt %, or 15 wt % to 20 wt %.

The electrolyte can include a salt (e.g., conducting salt). The salt can include LiPF₆, LiC₂F₆NO₄S₂(lithium bis(trifluoromethanesulfonyl)imide, LiTFSI), LiBF₄, or a combination thereof. The salt can include LiPF₆ in a range of 0 mol/L to 2.0 mol/L. For example, the salt can include LiPF₆ in a range of 0 mol/L to 0.5 mol/L, 0 mol/L to 1.0 mol/L, 0 mol/L to 1.5 mol/L, 0 mol/L to 2.0 mol/L, 0.5 mol/L to 1.0 mol/L, 0.5 mol/L to 1.5 mol/L, 0.5 mol/L to 2.0 mol/L, 1.0 mol/L to 1.5 mol/L, 1.0 mol/L to 2.0 mol/L, or 1.5 mol/L to 2.0 mol/L.

The salt can include LiTFSI in a range of 0 mol/L to 1.0 mol/L. For example, the salt can include LiTFSI in a range of 0 mol/L to 0.25 mol/L, 0 mol/L to 0.5 mol/L, 0 mol/L to 0.75 mol/L, 0 mol/L to 1.0 mol/L, 0.25 mol/L to 0.5 mol/L, 0.25 mol/L to 0.75 mol/L, 0.25 mol/L to 1.0 mol/L, 0.5 mol/L to 0.75 mol/L, 0.5 mol/L to 1.0 mol/L, or 0.75 mol/L to 1.0 mol/L.

The salt can include LiBF₄ in a range of 0 mol/L to 1.0 mol/L. For example, the salt can include LiBF₄ in a range of 0 mol/L to 0.25 mol/L, 0 mol/L to 0.5 mol/L, 0 mol/L to 0.75 mol/L, 0 mol/L to 1.0 mol/L, 0.25 mol/L to 0.5 mol/L, 0.25 mol/L to 0.75 mol/L, 0.25 mol/L to 1.0 mol/L, 0.5 mol/L to 0.75 mol/L, 0.5 mol/L to 1.0 mol/L, or 0.75 mol/L to 1.0 mol/L.

The electrolyte can include a binary salt. The binary salt can include a first salt and a second salt. The first salt can include LiPF₆, LiTFSI, or LiBF₄. The second salt can include LiPF₆, LiTFSI, or LiBF₄. The first salt can be different from the second salt. The binary salt can have a total salt concentration of less than or equal to 2 mol/L. For example, the binary salt can have a total salt concentration of less than or equal to 2 mol/L, less than or equal to 1.75 mol/L, less than or equal to 1.5 mol/L, less than or equal to 1.25 mol/L, less than or equal to 1 mol/L, less than or equal to 0.75 mol/L, less than or equal to 0.5 mol/L, or less than or equal to 0.25 mol/L.

The impedance of the battery cell 120 can be decreased compared to the same battery cell without the ethylene sulfite. For example, the impedance of the battery cell 120 at room temperature can be decreased compared to the same battery cell without the ethylene sulfite. For example, the impedance of the battery cell 120 at a temperature less than or equal to −10° C. can be decreased compared to the same battery cell without the ethylene sulfite. The capacity retention of the battery cell 120 can be increased compared to the same battery cell without the ethylene sulfite. For example, the capacity retention of the battery cell 120 at a temperature greater than or equal to 45° C. can be increased compared to the same battery cell without the ethylene sulfite.

The battery cell 120 can achieve at least 80% state of charge from 0% state of charge in less than 25 minutes. For example, the battery cell 120 can achieve at least 80% state of charge from 0% state of charge in less than 25 minutes, at least 80% state of charge from 0% state of charge in less than 20 minutes, at least 80% state of charge from 0% state of charge in less than 15 minutes, at least 80% state of charge from 0% state of charge in less than 10 minutes, at least 80% state of charge from 0% state of charge in less than 5 minutes, at least 85% state of charge from 0% state of charge in less than 25 minutes, at least 85% state of charge from 0% state of charge in less than 20 minutes, at least 85% state of charge from 0% state of charge in less than 15 minutes, at least 85% state of charge from 0% state of charge in less than 10 minutes, at least 90% state of charge from 0% state of charge in less than 25 minutes, at least 90% state of charge from 0% state of charge in less than 20 minutes, at least 95% state of charge from 0% state of charge in less than 25 minutes, at least 95% state of charge from 0% state of charge in less than 20 minutes, 100% state of charge from 0% state of charge in less than 25 minutes, or 100% state of charge from 0% state of charge in less than 20 minutes.

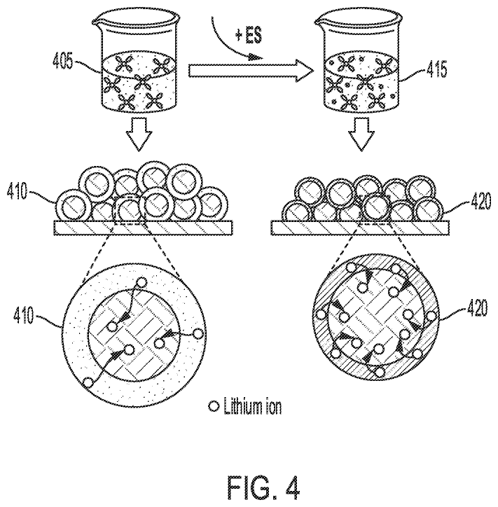

FIG. 4 depicts a schematic illustration of a solid electrolyte interphase 410 formed from an electrolyte 405 without ethylene sulfite and a solid electrolyte interphase 420 formed from an electrolyte 415 with ethylene sulfite. The solid electrolyte interphase 410 can be formed from the electrolyte 405. The electrolyte 405 can include fluoroethylene carbonate and vinylene carbonate. The electrolyte 405 can be free of ethylene sulfite. The solid electrolyte interphase 420 can be formed from the electrolyte 415. The electrolyte 415 can include fluoroethylene carbonate, ethylene sulfite, and vinylene carbonate. The electrolyte 415 can include the additive 305. The additive 305 can include fluoroethylene carbonate, ethylene sulfite, and vinylene carbonate. The electrolyte 415 can form the electrolyte layer 260. The solid electrolyte interphase 410 can be ionically conductive at low temperatures. For example, the solid electrolyte interphase 410 can be formed from the electrolyte 415 including fluoroethylene carbonate, ethylene sulfite, and vinylene carbonate can be ionically conductive at low temperatures.

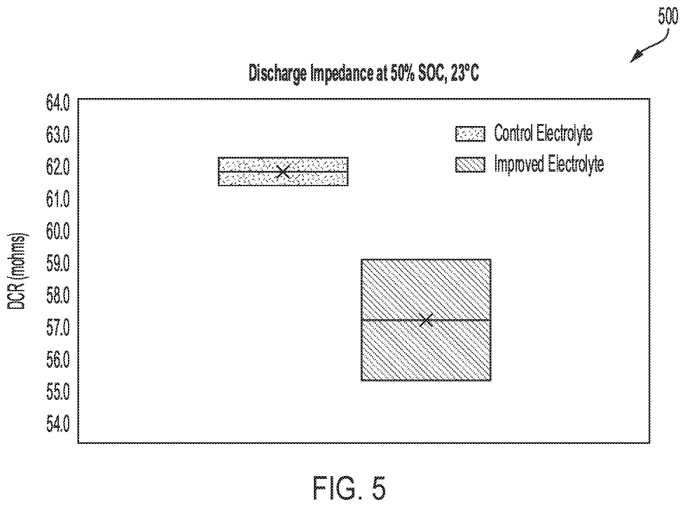

FIG. 5 depicts a graph of discharge impedance (e.g., direct current resistance, DCR; or, direct current internal resistance, DCIR) at 50% state-of-charge (SOC) at 23° C. (e.g., ambient temperature) for an improved electrolyte and a control electrolyte. The discharge impedance can be expressed in milliohms (e.g., mohms, mΩ). The data can be collected in 1.5 Ah pouch cells. Different sizes (in Ah) of battery cells can be used to collect such data. The impedance can be measured based on a discharging pulse of 2.5 C and 30 seconds. The improved electrolyte (e.g., electrolyte 415) can include fluoroethylene carbonate, ethylene sulfite, and vinylene carbonate. The control electrolyte (e.g., electrolyte 405) can include fluoroethylene carbonate and vinylene carbonate. The control electrolyte can be free of ethylene sulfite. The impedance of the improved electrolyte can be 11% less than the impedance of the control electrolyte for discharging. The impedance of the battery cell 120 with the improved electrolyte can be decreased compared to the same battery cell without the ethylene sulfite. For example, the impedance of the battery cell 120 with the improved electrolyte at room temperature can be decreased compared to the same battery cell without the ethylene sulfite.

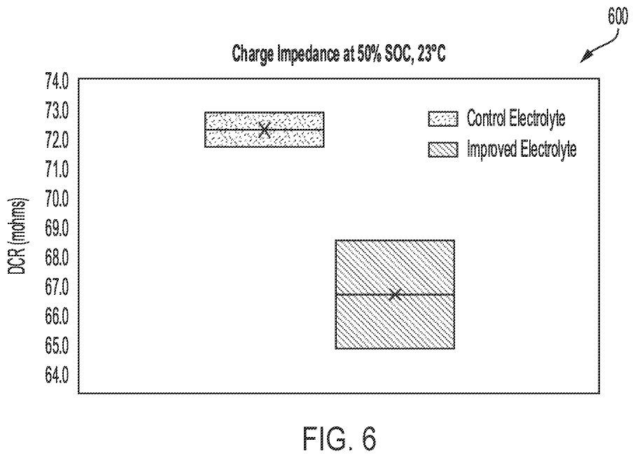

FIG. 6 depicts a graph of charge impedance at 50% state-of-charge at 23° C. for an improved electrolyte and a control electrolyte. The charge impedance can be expressed in milliohms. The data can be collected in 1.5 Ah pouch cells. Different sizes (in Ah) of battery cells can be used to collect such data. The impedance can be measured based on a charging pulse of 1.5 C and 30 seconds. The improved electrolyte (e.g., electrolyte 415) can include fluoroethylene carbonate, ethylene sulfite, and vinylene carbonate. The control electrolyte (e.g., electrolyte 405) can include fluoroethylene carbonate and vinylene carbonate. The control electrolyte can be free of ethylene sulfite. The impedance of the improved electrolyte can be 10% less than the impedance of the control electrolyte for charging. The impedance of the battery cell 120 with the improved electrolyte can be decreased compared to the same battery cell without the ethylene sulfite. For example, the impedance of the battery cell 120 with the improved electrolyte at room temperature can be decreased compared to the same battery cell without the ethylene sulfite.

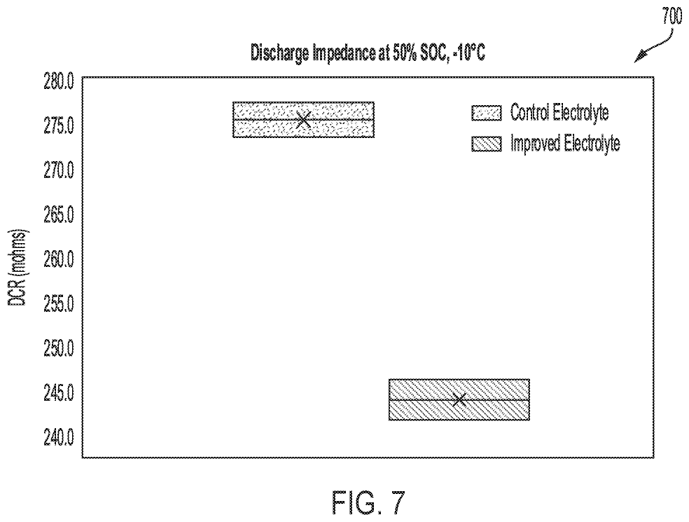

FIG. 7 depicts a graph of discharge impedance at 50% state-of-charge at −10° C. (e.g., low temperature) for an improved electrolyte and a control electrolyte. The discharge impedance can be expressed in milliohms. The data can be collected in 1.5 Ah pouch cells. Different sizes (in Ah) of battery cells can be used to collect such data. The impedance can be measured based on a discharging pulse of 1.5 C and 30 seconds. The improved electrolyte (e.g., electrolyte 415) can include fluoroethylene carbonate, ethylene sulfite, and vinylene carbonate. The control electrolyte (e.g., electrolyte 405) can include fluoroethylene carbonate and vinylene carbonate. The control electrolyte can be free of ethylene sulfite. The impedance of the improved electrolyte can be 12% less than the impedance of the control electrolyte for discharging. The impedance of the battery cell 120 with the improved electrolyte can be decreased compared to the same battery cell without the ethylene sulfite. For example, the impedance of the battery cell 120 with the improved electrolyte at a temperature less than or equal to −10° C. can be decreased compared to the same battery cell without the ethylene sulfite.

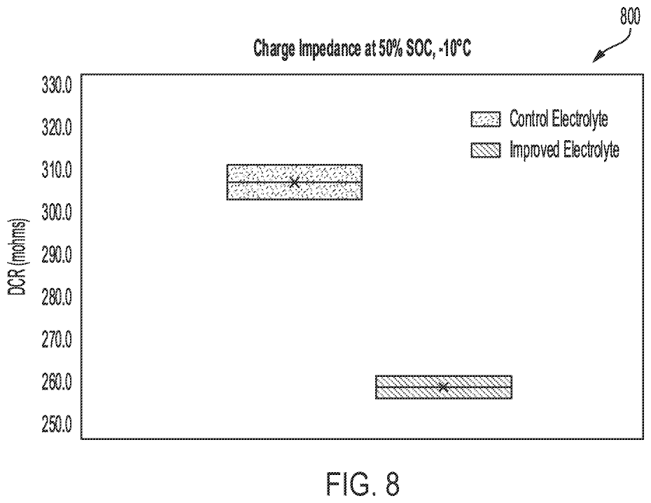

FIG. 8 depicts a graph of charge impedance at 50% state-of-charge at −10° C. for an improved electrolyte and a control electrolyte. The charge impedance can be expressed in milliohms. The data can be collected in 1.5 Ah pouch cells. Different sizes (in Ah) of battery cells can be used to collect such data. The impedance can be measured based on a charging pulse of 1.0 C and 30 seconds. The improved electrolyte (e.g., electrolyte 415) can include fluoroethylene carbonate, ethylene sulfite, and vinylene carbonate. The control electrolyte (e.g., electrolyte 405) can include fluoroethylene carbonate and vinylene carbonate. The control electrolyte can be free of ethylene sulfite. The impedance of the improved electrolyte can be 16% less than the impedance of the control electrolyte for charging. The impedance of the battery cell 120 with the improved electrolyte can be decreased compared to the same battery cell without the ethylene sulfite. For example, the impedance of the battery cell 120 with the improved electrolyte at a temperature less than or equal to −10° C. can be decreased compared to the same battery cell without the ethylene sulfite.

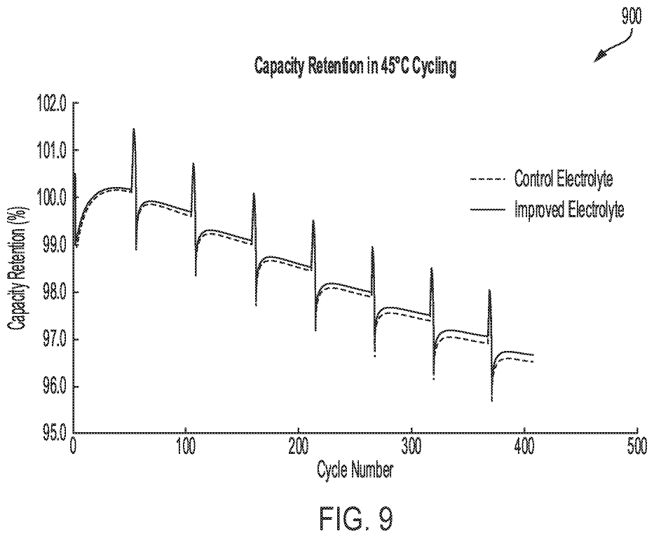

FIG. 9 depicts a plot of capacity retention vs. cycle number at 45° C. for an improved electrolyte and a control electrolyte. The capacity retention can be measured at an elevated temperature of 45° C. The capacity retention can be measured at room temperature (e.g., 25° C.) or low temperature (−10° C. or below). The capacity retention can be expressed as a percentage (%). The data can be collected in 1.5 Ah pouch cells. Different sizes (in Ah) of battery cells can be used to collect such data. The cells can be cycled at 1.0 C charging and 1.5 C discharging conditions. The improved electrolyte (e.g., electrolyte 415) can include fluoroethylene carbonate, ethylene sulfite, and vinylene carbonate. The control electrolyte (e.g., electrolyte 405) can include fluoroethylene carbonate and vinylene carbonate. The control electrolyte can be free of ethylene sulfite. The cell capacity (e.g., battery cell capacity) decay of the improved electrolyte can be 4% less by 400 cycles than the cell capacity decay of the control electrolyte. The capacity retention of the battery cell 120 with the improved electrolyte can be increased compared to the same battery cell without the ethylene sulfite. For example, the capacity retention of the battery cell 120 with the improved electrolyte at a temperature greater than or equal to 45° C. can be increased compared to the same battery cell without the ethylene sulfite.

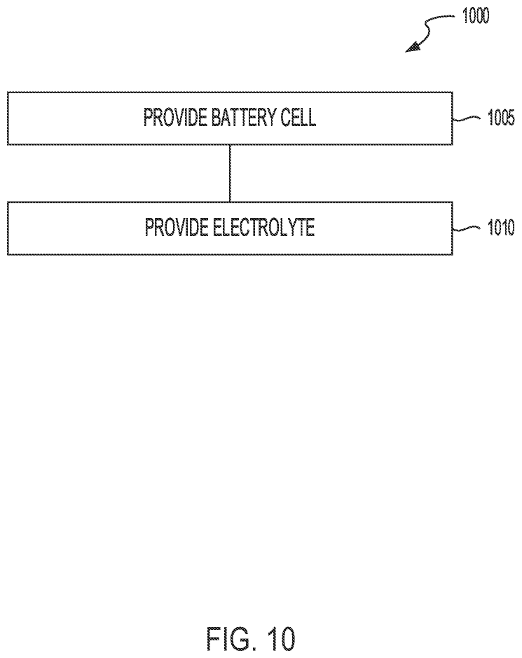

FIG. 10 depicts a method of improving battery cell performance. The method 1000 can include providing the battery cell 120 (ACT 1005). The method 1000 can include providing the electrolyte (ACT 1010).

The method 1000 can include providing the battery cell 120 (ACT 1005). The battery cell 120 can include one or more materials with various electrical conductivity or thermal conductivity, or a combination thereof. The battery cell 120 can include the anode layer 245 or anode. The anode can include an anode active material. The anode active material can include artificial graphite, natural graphite, or a combination thereof. The anode active material can have an areal density of at least 4.8 mg/cm². For example, the anode active material can have an areal density of at least 4.8 mg/cm², at least 5 mg/cm², at least 10 mg/cm², or at least 15 mg/cm². The anode active material can have an areal density in a range of 4.8 mg/cm² to 20 mg/cm². For example, the anode active material can have an areal density in a range of 4.8 mg/cm² to 5 mg/cm², 4.8 mg/cm² to 10 mg/cm², 4.8 to 15 mg/cm², 4.8 to 20 mg/cm², 5 mg/cm² to 10 mg/cm², 5 to 15 mg/cm², 5 to 20 mg/cm², 10 to 15 mg/cm², 10 to 20 mg/cm², or 15 to 20 mg/cm². The anode active material can exhibit an areal density in the range of 4.8 mg/cm² to 20 mg/cm² on a single side of a current collector. The anode active material can have a press density of at least 1.4 g/cm³. For example, the anode active material can have a press density of at least 1.4 g/cm³, at least 1.5 g/cm³, at least 1.6 g/cm³, at least 1.7 g/cm³, at least 1.8 g/cm³, or at least 1.9 g/cm³. The anode active material can have a press density in a range of 1.4 g/cm³ to 2.0 g/cm³. For example, the anode active material can have a press density in a range of 1.4 g/cm³ to 1.6 g/cm³, 1.4 g/cm³ to 1.8 g/cm³, 1.4 g/cm³ to 2.0 g/cm³, 1.6 g/cm³ to 1.8 g/cm³, 1.6 g/cm³ to 2.0 g/cm³, or 1.8 g/cm³ to 2.0 g/cm³. The press density can be measured after a calendaring or roll pressing of the electrode.

The battery cell 120 can include the cathode layer 255 or cathode. The cathode can include a cathode active material. The cathode active material can include lithium iron phosphate (e.g., LiFePO₄, LFP), lithium manganese iron phosphate (LMFP), nickel manganese, and cobalt (NMC), nickel, cobalt, and aluminum (NCA), lithium cobalt oxide (LCO), over-lithiated layered oxides (OLO), or a combination thereof. The cathode active material can have an areal density of at least 12 mg/cm². For example, the cathode active material can have an areal density of at least 12 mg/cm², at least 15 mg/cm², at least 20 mg/cm², at least 25 mg/cm², or at least 30 mg/cm². The cathode active material can have an areal density in a range of 12 mg/cm² to 35 mg/cm². For example, the cathode active material can have an areal density in a range of 12 mg/cm² to 15 mg/cm², 12 mg/cm² to 20 mg/cm², 12 mg/cm² to 25 mg/cm², 12 mg/cm² to 30 mg/cm², 12 mg/cm² to 35 mg/cm², 15 mg/cm² to 20 mg/cm², 15 mg/cm² to 25 mg/cm², 15 mg/cm² to 30 mg/cm², 15 mg/cm² to 35 mg/cm², 20 mg/cm² to 25 mg/cm², 20 mg/cm² to 30 mg/cm², 20 mg/cm² to 35 mg/cm², 25 mg/cm² to 30 mg/cm², 25 mg/cm² to 35 mg/cm², or 30 mg/cm² to 35 mg/cm². The cathode active material can exhibit an areal density in the range of 12 mg/cm² to 30 mg/cm² on a single side of a current collector. The cathode active material can have a press density of at least 2.0 g/cm³. For example, the cathode active material can have a press density of at least 2.0 g/cm³, or at least 3.0 g/cm³. The cathode active material can have a press density in a range of 2.0 g/cm³ to 4.0 g/cm³. For example, the cathode active material can have a press density of 2.0 g/cm³ to 2.5 g/cm³, 2.0 g/cm³ to 3.0 g/cm³, 2.0 g/cm³ to 3.5 g/cm³, 2.0 to 4.0 g/cm³, 2.5 g/cm³ to 3.0 g/cm³, 2.5 g/cm³ to 3.5 g/cm³, 2.5 to 4.0 g/cm³, 3.0 g/cm³ to 3.5 g/cm³, 3.0 to 4.0 g/cm³, or 3.5 to 4.0 g/cm³. The press density can be measured after a calendaring or roll pressing of the electrode.

The method 1000 can include operating the battery cell 120 at a temperature of greater than or equal to 45° C. The method 1000 can include operating the battery cell 120 at a temperature of less than or equal to −10° C. The method 1000 can include charging the battery cell 120 to at least 80% state of charge in less than 25 minutes.

The method 1000 can include providing the electrolyte (ACT 1010). The electrolyte can include the additive 305. The additive 305 can include a ring-opening compound. The ring-opening compound can include a fluorocarbonate. The fluorocarbonate can include fluoroethylene carbonate (FEC). The ring-opening compound can increase decomposition of the heterocyclic compound in the electrolyte compared to the same electrolyte without the ring-opening compound. For example, the ring-opening compound can increase decomposition of a sulfite in an electrolyte compared to the same electrolyte without the ring-opening compound. The electrolyte can include a solvent. The solvent can include dimethyl carbonate.

The additive 305 can include fluoroethylene carbonate. The additive 305 can include fluoroethylene carbonate in a range of 0.1 wt % to 10 wt %. For example, the additive 305 can include fluoroethylene carbonate in a range of 0.1 wt % to 0.5 wt %, 0.1 wt % to 1 wt %, 0.1 wt % to 2 wt %, 0.1 wt % to 5 wt %, 0.1 wt % to 10 wt %, 0.5 wt % to 1 wt %, 0.5 wt % to 2 wt %, 0.5 wt % to 5 wt %, 0.5 wt % to 10 wt %, 2 wt % to 2 wt %, 2 wt % to 5 wt %, 2 wt % to 10 wt %, 2 wt % to 5 wt %, 2 wt % to 10 wt %, or 1 wt % to 10 wt %.

The additive 305 can include a heterocyclic compound. For example, the heterocyclic compound can include a sultone, a sulfonate, a sulfite (e.g., ethylene sulfite, ES), or a combination thereof. The additive 305 can include the heterocyclic compound in a range of 0.1 wt % to 5 wt %. For example, the additive 305 can include the heterocyclic compound in a range of 0.1 wt % to 0.5 wt %, 0.1 wt % to 1 wt %, 0.1 wt % to 2 wt %, 0.1 wt % to 3 wt %, 0.1 wt % to 4 wt %, 0.1 wt % to 5 wt %, 0.5 wt % to 1 wt %, 0.5 wt % to 2 wt %, 0.5 wt % to 3 wt %, 0.5 wt % to 4 wt %, 0.5 wt % to 5 wt %, 1 wt % to 2 wt %, 1 wt % to 3 wt %, 1 wt % to 4 wt %, 1 wt % to 5 wt %, 2 wt % to 3 wt %, 2 wt % to 4 wt %, 2 wt % to 5 wt %, 3 wt % to 4 wt %, 3 wt % to 5 wt %, or 4 wt % to 5 wt %. The fluoroethylene carbonate can facilitate decomposition of the heterocyclic compound. For example, the fluoroethylene carbonate can facilitate the ring-opening decomposition of the ethylene sulfite. The decomposition of ethylene sulfite can be hindered by a dimethyl carbonate (DMC) co-solvent. Dimethyl carbonate can reduce the conductivity of the electrolyte at low temperatures.

The additive 305 can include vinylene carbonate. The additive 305 can include vinylene carbonate in a range of 0.1 wt % to 5 wt %. For example, the additive 305 can include vinylene carbonate in a range of 0.1 wt % to 0.5 wt %, 0.1 wt % to 1 wt %, 0.1 wt % to 2 wt %, 0.1 wt % to 3 wt %, 0.1 wt % to 4 wt %, 0.1 wt % to 5 wt %, 0.5 wt % to 1 wt %, 0.5 wt % to 2 wt %, 0.5 wt % to 3 wt %, 0.5 wt % to 4 wt %, 0.5 wt % to 5 wt %, 1 wt % to 2 wt %, 1 wt % to 3 wt %, 1 wt % to 4 wt %, 1 wt % to 5 wt %, 2 wt % to 3 wt %, 2 wt % to 4 wt %, 2 wt % to 5 wt %, 3 wt % to 4 wt %, 3 wt % to 5 wt %, or 4 wt % to 5 wt %.

The additive 305 can include tris(trimethylsilyl) phosphate (TMSPa). Each tris(trimethylsilyl) phosphate molecule can possess four oxygen atoms in the forms of P═O and P—O—Si. The additive 305 can include tris(trimethylsilyl) phosphate in a range of 0 wt % to 1 wt %. For example, the additive 305 can include tris(trimethylsilyl) phosphate in a range of 0 wt % to 0.25 wt %, 0 wt % to 0.5 wt %, 0 wt % to 0.75 wt %, 0 wt % to 1 wt %, 0.25 wt % to 0.5 wt %, 0.25 wt % to 0.75 wt %, 0.25 wt % to 1 wt %, 0.5 wt % to 0.75 wt %, 0.5 wt % to 1 wt %, or 0.75 wt % to 1 wt %. The additive 305 can include (R₃SiO)₃P(O), (R₃SiO)₃P, or mixture of any two or more thereof. R can include methyl or ethyl. R can include a C₁-C₄ alkyl group. For example, the additive 305 can include (R₃SiO)₃P(O), (R₃SiO)₃P, or mixture of any two or more thereof in a range of 0 wt % to 0.25 wt %, 0 wt % to 0.5 wt %, 0 wt % to 0.75 wt %, 0 wt % to 1 wt %, 0.25 wt % to 0.5 wt %, 0.25 wt % to 0.75 wt %, 0.25 wt % to 1 wt %, 0.5 wt % to 0.75 wt %, 0.5 wt % to 1 wt %, or 0.75 wt % to 1 wt %.

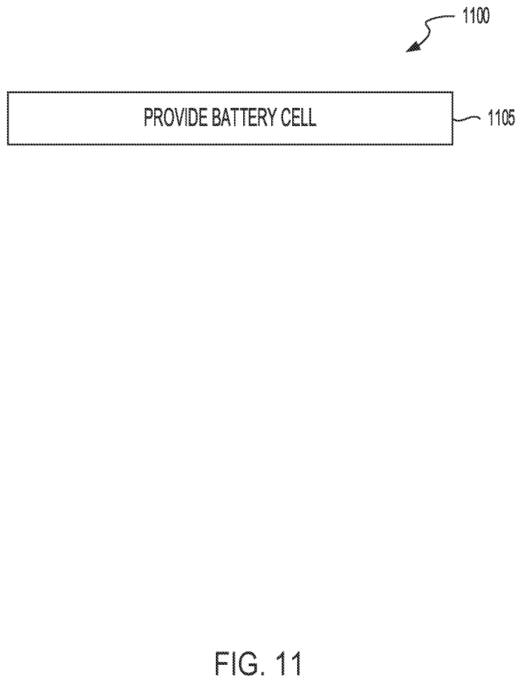

FIG. 11 depicts a method 1100 of providing the battery cell 120. The battery cell 120 can include one or more materials with various electrical conductivity or thermal conductivity, or a combination thereof. The battery cell 120 can include the anode layer 245 or anode. The anode can include an anode active material. The anode active material can include artificial graphite, natural graphite, or a combination thereof. The anode active material can have an areal density of at least 4.8 mg/cm². For example, the anode active material can have an areal density of at least 4.8 mg/cm², at least 5 mg/cm², at least 10 mg/cm², or at least 15 mg/cm². The anode active material can have an areal density in a range of 4.8 mg/cm² to 20 mg/cm². For example, the anode active material can have an areal density in a range of 4.8 mg/cm² to 5 mg/cm², 4.8 mg/cm² to 10 mg/cm², 4.8 to 15 mg/cm², 4.8 to 20 mg/cm², 5 mg/cm² to 10 mg/cm², 5 to 15 mg/cm², 5 to 20 mg/cm², 10 to 15 mg/cm², 10 to 20 mg/cm², or 15 to 20 mg/cm². The anode active material can exhibit an areal density in the range of 4.8 mg/cm² to 20 mg/cm² on a single side of a current collector. The anode active material can have a press density of at least 1.4 g/cm³. For example, the anode active material can have a press density of at least 1.4 g/cm³, at least 1.5 g/cm³, at least 1.6 g/cm³, at least 1.7 g/cm³, at least 1.8 g/cm³, or at least 1.9 g/cm³. The anode active material can have a press density in a range of 1.4 g/cm³ to 2.0 g/cm³. For example, the anode active material can have a press density in a range of 1.4 g/cm³ to 1.6 g/cm³, 1.4 g/cm³ to 1.8 g/cm³, 1.4 g/cm³ to 2.0 g/cm³, 1.6 g/cm³ to 1.8 g/cm³, 1.6 g/cm³ to 2.0 g/cm³, or 1.8 g/cm³ to 2.0 g/cm³. The press density can be measured after a calendaring or roll pressing of the electrode.

The battery cell 120 can include the cathode layer 255 or cathode. The cathode can include a cathode active material. The cathode active material can include lithium iron phosphate (e.g., LiFePO₄, LFP), lithium manganese iron phosphate (LMFP), nickel manganese, and cobalt (NMC), nickel, cobalt, and aluminum (NCA), lithium cobalt oxide (LCO), over-lithiated layered oxides (OLO), or a combination thereof. The cathode active material can have an areal density of at least 12 mg/cm². For example, the cathode active material can have an areal density of at least 12 mg/cm², at least 15 mg/cm², at least 20 mg/cm², at least 25 mg/cm², or at least 30 mg/cm². The cathode active material can have an areal density in a range of 12 mg/cm² to 35 mg/cm². For example, the cathode active material can have an areal density in a range of 12 mg/cm² to 15 mg/cm², 12 mg/cm² to 20 mg/cm², 12 mg/cm² to 25 mg/cm², 12 mg/cm² to 30 mg/cm², 12 mg/cm² to 35 mg/cm², 15 mg/cm² to 20 mg/cm², 15 mg/cm² to 25 mg/cm², 15 mg/cm² to 30 mg/cm², 15 mg/cm² to 35 mg/cm², 20 mg/cm² to 25 mg/cm², 20 mg/cm² to 30 mg/cm², 20 mg/cm² to 35 mg/cm², 25 mg/cm² to 30 mg/cm², 25 mg/cm² to 35 mg/cm², or 30 mg/cm² to 35 mg/cm². The cathode active material can exhibit an areal density in the range of 12 mg/cm² to 30 mg/cm² on a single side of a current collector. The cathode active material can have a press density of at least 2.0 g/cm³. For example, the cathode active material can have a press density of at least 2.0 g/cm³, or at least 3.0 g/cm³. The cathode active material can have a press density in a range of 2.0 g/cm³ to 4.0 g/cm³. For example, the cathode active material can have a press density of 2.0 g/cm³ to 2.5 g/cm³, 2.0 g/cm³ to 3.0 g/cm³, 2.0 g/cm³ to 3.5 g/cm³, 2.0 to 4.0 g/cm³, 2.5 g/cm³ to 3.0 g/cm³, 2.5 g/cm³ to 3.5 g/cm³, 2.5 to 4.0 g/cm³, 3.0 g/cm³ to 3.5 g/cm³, 3.0 to 4.0 g/cm³, or 3.5 to 4.0 g/cm³. The press density can be measured after a calendaring or roll pressing of the electrode.

At least one aspect is directed to the electric vehicle 105. The electric vehicle 105 can include the battery cell 120. The battery cell 120 can include a cathode. The cathode can include a cathode active material. The battery cell 120 can include an anode. The anode can include an anode active material. The battery cell 120 can include an electrolyte. The electrolyte can include a ring-opening compound. The ring-opening compound can include a fluorocarbonate. The electrolyte can include a heterocyclic compound. The electrolyte can include dimethyl carbonate. The ring-opening compound can increase decomposition of the heterocyclic compound in the electrolyte compared to the same electrolyte without the ring-opening compound. The electrolyte can include an additive 305. The additive 305 can include fluoroethylene carbonate in a range of 0.1 wt % to 10 wt %. The additive 305 can include ethylene sulfite in a range of 0.1 wt % to 5 wt %. The additive 305 can include vinylene carbonate in a range of 0.1 wt % to 5 wt %. The additive 305 can include a ring-opening compound. The ring-opening compound can include a fluorocarbonate. The ring-opening compound can increase decomposition of a sulfite in an electrolyte including dimethyl carbonate compared to the same electrolyte including dimethyl carbonate without the ring-opening compound. The additive 305 can include tris(trimethylsilyl) phosphate in a range of 0 wt % to 1 wt %. The additive 305 can include (R₃SiO)₃P(O), (R₃SiO)₃P, or mixture of any two or more thereof. R can include methyl or ethyl. R can include a C₁-C₄ alkyl group. For example, the additive 305 can include (R₃SiO)₃P(O), (R₃SiO)₃P, or mixture of any two or more thereof.

The system can include the battery cell 120. The battery cell 120 can include a cathode. The cathode can include a cathode active material. The battery cell 120 can include an anode. The anode can include an anode active material. The battery cell 120 can include an electrolyte. The electrolyte can include a ring-opening compound. The ring-opening compound can include a fluorocarbonate. The electrolyte can include a heterocyclic compound. The electrolyte can include dimethyl carbonate. The ring-opening compound can increase decomposition of the heterocyclic compound in the electrolyte compared to the same electrolyte without the ring-opening compound. The electrolyte can include an additive 305. The additive 305 can include fluoroethylene carbonate in a range of 0.1 wt % to 10 wt %. The additive 305 can include ethylene sulfite in a range of 0.1 wt % to 5 wt %. The additive 305 can include vinylene carbonate in a range of 0.1 wt % to 5 wt %. The additive 305 can include a ring-opening compound. The ring-opening compound can include a fluorocarbonate. The ring-opening compound can increase decomposition of a sulfite in an electrolyte including dimethyl carbonate compared to the same electrolyte including dimethyl carbonate without the ring-opening compound. The additive 305 can include tris(trimethylsilyl) phosphate in a range of 0 wt % to 1 wt %. The additive 305 can include (R₃SiO)₃P(O), (R₃SiO)₃P, or mixture of any two or more thereof. R can include methyl or ethyl. R can include a C₁-C₄ alkyl group. For example, the additive 305 can include (R₃SiO)₃P(O), (R₃SiO)₃P, or mixture of any two or more thereof.

At least one aspect is directed to a battery. The battery can include a cathode. The cathode can include a cathode active material. The battery can include an anode. The anode can include an anode active material. The battery can include an electrolyte. The electrolyte can include a ring-opening compound. The ring-opening compound can include a fluorocarbonate. The electrolyte can include a heterocyclic compound. The electrolyte can include dimethyl carbonate. The ring-opening compound can increase decomposition of the heterocyclic compound in the electrolyte compared to the same electrolyte without the ring-opening compound. The electrolyte can include an additive 305. The additive 305 can include fluoroethylene carbonate in a range of 0.1 wt % to 10 wt %. The additive 305 can include ethylene sulfite in a range of 0.1 wt % to 5 wt %. The additive 305 can include vinylene carbonate in a range of 0.1 wt % to 5 wt %. The additive 305 can include a ring-opening compound. The ring-opening compound can include a fluorocarbonate. The ring-opening compound can increase decomposition of a sulfite in an electrolyte including dimethyl carbonate compared to the same electrolyte including dimethyl carbonate without the ring-opening compound. The additive 305 can include tris(trimethylsilyl) phosphate in a range of 0 wt % to 1 wt %. The additive 305 can include (R₃SiO)₃P(O), (R₃SiO)₃P, or mixture of any two or more thereof. R can include methyl or ethyl. R can include a C₁-C₄ alkyl group. For example, the additive 305 can include (R₃SiO)₃P(O), (R₃SiO)₃P, or mixture of any two or more thereof.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

As used herein, the term “areal density” refers to the density at which the active material is packed in a given area (i.e. square centimeter). Higher density can provide higher capacity. Similarly, the “press density” refers to the density at which the active material is packed in a specified volume (i.e. cubic centimeter). Higher density can provide higher capacity.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A battery cell, comprising:
a cathode comprising a cathode active material;
an anode comprising an anode active material; and
an electrolyte, comprising:
a ring-opening compound comprising a fluorocarbonate;
a heterocyclic compound; and
dimethyl carbonate;
wherein the ring-opening compound increases decomposition of the heterocyclic compound in the electrolyte compared to the same electrolyte without the ring-opening compound.

2. The battery cell of claim 1, comprising:
the ring-opening compound comprising fluoroethylene carbonate; and
the heterocyclic compound comprising a sultone, a sulfonate, a sulfite, or a combination thereof.

3. The battery cell of claim 1, comprising:
the ring-opening compound comprising fluoroethylene carbonate;
the heterocyclic compound comprising ethylene sulfite; and
the electrolyte further comprising vinylene carbonate.

4. The battery cell of claim 1, wherein the electrolyte comprises:
the ring-opening compound comprising fluoroethylene carbonate; and
ethylene sulfite, vinylene carbonate, and tris(trimethylsilyl) phosphate.

5. The battery cell of claim 1, comprising:
the ring-opening compound comprising fluoroethylene carbonate in a range of 0.1 wt % to 10 wt %;
ethylene sulfite in a range of 0.1 wt % to 5 wt %;
vinylene carbonate in a range of 0.1 wt % to 5 wt %; and
tris(trimethylsilyl) phosphate in a range of 0 wt % to 1 wt %.

6. A battery cell, comprising:
a cathode comprising a cathode active material;
an anode comprising an anode active material; and
an electrolyte comprising:
fluoroethylene carbonate;
ethylene sulfite; and
vinylene carbonate.

7. The battery cell of claim 6, comprising:
fluoroethylene carbonate in a range of 0.1 wt % to 10 wt %;
ethylene sulfite in a range of 0.1 wt % to 5 wt %;
vinylene carbonate in a range of 0.1 wt % to 5 wt %; and
(R3SiO)3P(O), (R3SiO)3P, or a mixture of any two or more thereof in a range of 0 wt % to 1 wt %.

8. The battery cell of claim 6, comprising:
fluoroethylene carbonate in a range of 0.1 wt % to 10 wt %;
ethylene sulfite in a range of 0.1 wt % to 5 wt %;
vinylene carbonate in a range of 0.1 wt % to 5 wt %; and
tris(trimethylsilyl) phosphate in a range of 0 wt % to 1 wt %.

9. The battery cell of claim 6, wherein an impedance of the battery cell is decreased compared to the same battery cell without the ethylene sulfite.

10. The battery cell of claim 6, wherein an impedance of the battery cell at room temperature is decreased compared to the same battery cell without the ethylene sulfite.

11. The battery cell of claim 6, wherein an impedance of the battery cell at a temperature less than or equal to −10° C. is decreased compared to the same battery cell without the ethylene sulfite.

12. The battery cell of claim 6, wherein the fluoroethylene carbonate facilitates decomposition of the ethylene sulfite.

13. The battery cell of claim 6, wherein the electrolyte comprises a solvent comprising ethylene carbonate, propylene carbonate, ethyl methyl carbonate, dimethyl carbonate, ethyl propionate, or a combination thereof.

14. The battery cell of claim 6, wherein the cathode active material has an areal density of at least 12 mg/cm² and a press density of at least 2.0 g/cm³.

15. The battery cell of claim 6, wherein the anode active material has an areal density of at least 4.8 mg/cm² and a press density of at least 1.4 g/cm³.

16. The battery cell of claim 6, wherein a capacity retention of the battery cell at a temperature greater than or equal to 45° C. is increased compared to the same battery cell without the ethylene sulfite.

17. A method, comprising:
providing a battery cell comprising:
a cathode comprising a cathode active material; and
an anode comprising an anode active material; and
providing an electrolyte comprising:
a ring-opening compound comprising a fluorocarbonate;
a heterocyclic compound; and
dimethyl carbonate;
wherein the ring-opening compound increases decomposition of the heterocyclic compound in the electrolyte compared to the same electrolyte without the ring-opening compound.

18. The method of claim 17, wherein:
the cathode active material has an areal density of at least 12 mg/cm² and a press density of at least 2.0 g/cm³; and
the anode active material has an areal density of at least 4.8 mg/cm² and a press density of at least 1.4 g/cm³.

19. The method of claim 17, wherein:
the ring-opening compound comprises fluoroethylene carbonate; and
the electrolyte comprises ethylene sulfite, vinylene carbonate, and tris(trimethylsilyl) phosphate.

20. The method of claim 17, wherein the electrolyte comprises:
fluoroethylene carbonate in a range of 0.1 wt % to 10 wt %;
ethylene sulfite in a range of 0.1 wt % to 5 wt %;
vinylene carbonate in a range of 0.1 wt % to 5 wt %; and
tris(trimethylsilyl) phosphate in a range of 0 wt % to 1 wt %.
